(19) United States
(12) Patent Application Publication
(10) Pub. No.: US 2025/0036148 A1
(43) Pub. Date: Jan. 30, 2025

(54) ROUTE PLANNING SYSTEM FOR A FORAGE HARVESTING CHAIN

(71) Applicant: CLAAS Selbstfahrende Erntemaschinen GmbH, Harsewinkel (DE)

(72) Inventors: Philipp Mümken, Biberach an der Riß (DE); Josef Fischer, Biberach (DE); Martin Reinhardt, Hohentengen (DE); Christian Schmid, Owingen (DE); Magnus Rupp, Rosenberg (DE); Sascha Pflanze, Bad Saulgau (DE); Andreas Mock, Wolpertswende (DE); Martin Ober, Trichtingen (DE); Joachim Oldenburg, Harsewinkel (DE); Michael Fugunt, Bad Wurzach (DE); Waldemar Thiesmann, Osnabrück (DE); Michael Becker, Hohentengen (DE)

(73) Assignee: CLAAS Selbstfahrende Erntemaschinen GmbH, Harsewinkel (DE)

(21) Appl. No.: 18/783,664

(22) Filed: Jul. 25, 2024

(30) Foreign Application Priority Data
Jul. 25, 2023 (DE) 102023119546.8

(51) Int. Cl. G05D 1/698; A01B 69/04; G05D 1/648; G05D 1/692; G05D 1/693; G05D 105/15; G05D 107/20

(52) U.S. Cl. CPC G05D 1/6987; A01B 69/008; G05D 1/648; G05D 1/692; G05D 1/693; G05D 2105/15; G05D 2107/21

(57) ABSTRACT

A route planning system configured to create a route plan of a forage harvesting process chain. The forage harvesting process chain comprises a plurality of agricultural work machines which perform a forage harvesting process in a predetermined order. The forage harvesting process comprises successive process steps with each process step being performed by a number of the plurality of agricultural work machines. The route planning system is further configured to generate a common route plan for the plurality of agricultural work machines of the forage harvesting process chain and/or an individualized route plan for each agricultural work machine of the plurality of agricultural work machines.

### CROSS REFERENCE TO RELATED APPLICATION

This application claims priority under 35 U.S.C. § 119 to German Patent Application No. DE 10 2023 119 546.8 filed Jul. 25, 2023, the entire disclosure of which is hereby incorporated by reference herein.

### TECHNICAL FIELD

The present invention relates to a route planning system which is configured to create the route plan of a forage harvesting process chain

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 3 314 997 B1 discloses a harvest management system that, by using suitable sensors, monitors the moisture of a forage crop to be harvested and controls downstream harvesting process steps depending on the detected crop moisture. In particular, it is disclosed therein that the so-called tedding or turning of the crop deposited on the field is controlled depending on the detected harvested material moisture. It is also described that the harvested crop is only harvested and pressed into bales using baling presses once a certain moisture content has been reached.

A wide range of route planning systems may describe the cooperation of a plurality of agricultural work machines on a territory to be worked. By way of example, US Patent Application Publication No. 2007/233374 A1, incorporated by reference herein in its entirety, discloses the cooperation of agricultural harvesting machines, such as combine harvesters, on a territory to be worked. The agricultural work machines may generate a route plan to be processed jointly, wherein the intention is to ensure that each area of the territory to be worked is worked by only one machine at a time.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic representation of a forage harvesting process.

FIG. 2 illustrates a schematic representation of the assistance system.

FIG. 3 illustrates a schematic representation of the relationship between the forage harvesting process and assistance system.

FIG. 4a illustrates a schematic representation of the route planning system.

FIG. 4b illustrates an example flow chart of the operation of the route planning system.

FIG. 5 illustrates a detailed structure of the route planning system.

FIG. 6 a schematic representation of route plan generation.

### DETAILED DESCRIPTION

As discussed in the background, EP 3 314 997 B1 discloses a harvest management system that monitors the moisture of a forage crop to be harvested and controls downstream harvesting process steps depending on the detected crop moisture. Such a system may have at least the advantage that individual steps of a forage harvesting process may be controlled depending on the detected crop moisture.

Against the backdrop that the individual harvesting process steps of a forage harvesting process chain may be performed at least partly simultaneously (such as entirely simultaneously) by completely different agricultural work machines on a territory to be worked or at completely different times on the same territory, it may be of great importance that the cooperation of the employed agricultural work machines is coordinated (such as automatically coordinated operation) in such a way that the agricultural work machines are used in the correct temporal and geographical sequence, and that no collisions occur between them when they are used at least partly automatically simultaneously. In addition, it may be advantageous if, in the interests of soil conservation, fewer passes were made over the territory to be worked.

Further, as discussed in the background, route planning systems discloses the cooperation of agricultural harvesting machines on a territory to be worked. Such systems have the disadvantage that they may only ever take into account work machines used simultaneously in a territory, and also prevent the cooperating agricultural work machines from working the same area of the territory to be worked.

It is therefore the object of the invention to avoid the described disadvantages of the prior art and, in particular, to disclose a route planning system which may take better account of the complex interrelationships of a forage harvesting process and may ensure that the agricultural work machines integrated in a forage harvesting process chain act in a coordinated manner on a territory to be worked.

In this regard, a route planning system is disclosed, configured to automatically generate the route plan of a forage harvesting process chain in order to at least partly automatically (such as entirely automatically) control one or more agricultural work machines. The forage harvesting process chain may comprise a plurality of agricultural work machines, which may perform a forage harvesting process in a predetermined order, wherein the forage harvesting process may comprise successive process steps, with one, some or each process step being performed by one or more of the plurality of agricultural work machines. The route planning system may also be configured to generate a common route plan for the plurality of agricultural work machines of the forage harvesting process chain and/or an individualized route plan for one, some or each agricultural work machine of the plurality of agricultural work machines performing the forage harvesting process. It may thus be ensured that the plurality of agricultural machines integrated into a forage harvesting process chain may act in a coordinated manner on the territory to be worked.

For example, the route plan, automatically generated by the route planning system, may automatically control at least one agricultural work machine. In one way, the at least one agricultural work machine may automatically implement the route plan in order to automatically control the at least one agricultural work machine. In another way, the route planning system may output the route plan (such as output the route plan on the touchscreen). After operator approval, the at least one agricultural work machine may automatically implement the route plan in order to automatically control the at least one agricultural work machine.

In one or some embodiments, the route planning system is configured to automatically dynamically adapt the common route plan and/or the individualized route plan generated for one, some or each agricultural work machine. In particular, this may have the effect that the travel routes of the plurality of agricultural work machines may be automatically and flexibly adapted to changing conditions on the territory to be worked.

In one or some embodiments, the route planning system is configured to generate a common route plan for the plurality of agricultural work machines in a process step of the forage harvesting process chain and/or an individualized route plan for one, some or each agricultural work machine. In this way, it may be ensured that some or all of the plurality of agricultural work machines involved in one and the same process step of a forage harvesting process chain may operate efficiently and collision-free on the territory to be worked.

By generating a common route plan for the plurality of agricultural work machines in all process steps of the forage harvesting process chain and/or an individualized route plan for each agricultural work machine, the route planning system may also ensure that a comprehensive route plan is created for all involved agricultural work machines across all process steps for the entire forage harvesting process chain. In this way, interactions between all agricultural work machines integrated into the forage harvesting process chain may be better taken into account, and may also be possible to automatically react very flexibly to changing boundary conditions.

In one or some embodiments, the common route plans and the individualized route plans may comprise travel routes, wherein one, some or each agricultural work machine is assigned an individualized travel route in the respective route plan. In particular, this may have the effect that the individualized travel routes may be used directly for entirely automated or at least partially automated steering of the respective agricultural work machine in a manner known per se.

In one or some embodiments, the forage harvesting process chain is generated by an assistance system and transferred (such as wired and/or wirelessly) to the route planning system, wherein the assistance system may create the forage harvesting process chain from a description of an agricultural job transferred to the assistance system. This may have the effect that the route plan to be generated may be very specifically adapted to the activities defined in the agricultural job.

In this context, it may also be advantageous if the forage harvesting process to be optimized is described as an agricultural job and the description of the agricultural job comprises the required process steps and the sequence of their execution, wherein the sequence of execution of the process steps forms the respective forage harvesting process chain, and wherein the route planning system is provided and configured to create a route plan for a process step and/or a route plan for a plurality or all process steps.

In one or some embodiments, the agricultural work machines active on a territory to be worked may each have a data transmission device, and the data transmission devices may be configured to enable a data exchange between the agricultural work machines and the route planning system. In particular, this may have the effect that the dynamic adaptation of the route plans and associated travel routes may take place automatically and promptly after the triggering event.

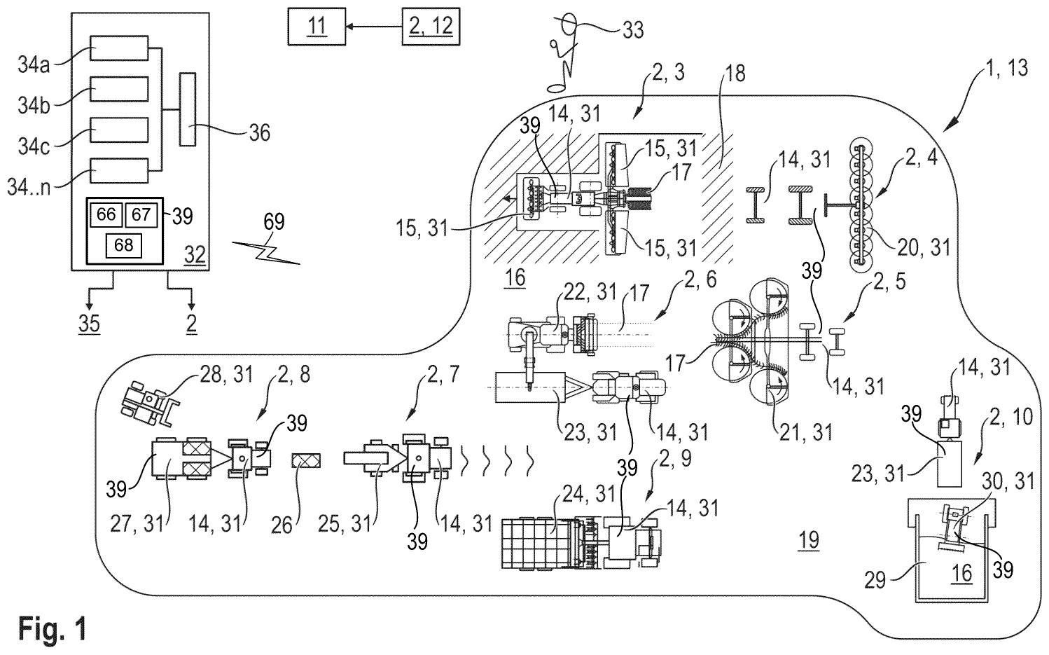

Referring to the figures, FIG. 1 schematically illustrates a forage harvesting process 1, wherein the depicted forage harvesting process 1 comprises a plurality of process steps 2 (which may be indicative of operations), described in more detail below. In particular, the process steps 2 may include any one, any combination, or all of the following illustrated in FIG. 1: mowing 3; turning or tedding 4; swathing 5; swath harvesting using a forage harvester 6; swath harvesting using a baler 7; collection and removal of the harvested material bales 8; swath harvesting using a loader wagon 9; and storage 10 of the harvested material 16. For reasons of simplification, FIG. 1 also shows alternative process steps 2, which may be mutually exclusive in practice, such as swath harvesting using a forage harvester 6, swath harvesting using a baler 7, or swath harvesting using a loader wagon 9. As discussed herein, part or all of the process steps 2 disclosed herein may be automatically executed (such as automatically controlled by the work parameters and/or the process steps determined by the assistance system). Thus, the above may provide a list of potentially available process steps from which to choose (and also from which to generate a sequence of process steps in order to perform the agricultural job).

In one or some embodiments, the forage harvesting process 1 may be described by the agricultural job 11 to be explained below and comprising an application-dependent selection of process steps 2 (from the potentially available process steps) and the sequence in which they are perform. Another process step 2 may be the decision about the start of harvesting 12 of the forage harvesting process 1. The process steps 2 describing the respective agricultural job 11 may hereinafter be referred to as the forage harvesting process chain 13.

In the embodiment depicted according to FIG. 1, the process step 2 mowing 3 (one example of a mechanical operation) is performed by a tractor 14 with front and side mowers 15, wherein the harvested material 16 is deposited in a single harvested material swath 17. It is within the scope of the invention that the three-part mower 15 may also be designed as only a one-part or two-part mower 15 and may form several crop swaths 17. In addition, the harvested material 16 may also be deposited in wide deposits 18 on the field soil 19 in process step 2 Mowing 3.

The process step 2 turning or tedding 4 (an example of a mechanical operation) may be implemented using a haymaking machine 20, also known as a turner or tedder, pulled by a tractor 14 or mounted thereon, and may be downstream (e.g., performed after) of process step 2 mowing 3, wherein in this case, the harvested material 16 may be deposited in a wide deposit 18 in process step 2 mowing 3. Process step 2 turning or tedding 4 may be performed once or several times, depending on the moisture of the harvested material 16 deposited in a wide deposit 18. In this regard, the haymaking machine, in its at least partly or fully automatic operation, may automatically sense (via a moisture sensor, a sensor operation, which is an example of an electrical operation) the moisture of the harvested material 16 deposited in the wide deposit 18, then may automatically determine whether to perform the process step 2 of turning or tedding 4 again (depending on comparing the value of the actual moisture from the moisture sensor with a designated value for the moisture of the harvested material 16, as work parameter, with the comparison determining whether to perform the process step 2 of turning or tedding 4 again), and responsive to determining to perform the process step 2 of turning or tedding 4 again, automatically control its movement to perform the process step 2 of turning or tedding 4 again.

If the harvested material 16 has been deposited in a wide deposit 18 on the field soil 19, the forage harvesting process chain 13 may comprise process step 2 of swathing 5. In embodiment depicted in FIG. 1, process step 2 of swathing 5 may be performed by a tractor 14-windrower 21 combination, wherein the windrower 21 is designed as a four-rotor swather and deposits the harvested material 16 in a single harvested material swath 17. However, the use of single-rotor or multi-rotor swathers is also contemplated here, which may deposit the harvested material 16 in one or more harvested material swaths 17 on the field soil 19.

In a first embodiment, the harvested material swath 17 may be picked up by a forage harvester 22, shredded in a manner known per se and transferred to a transport vehicle 23 pulled by a tractor 14. Alternatively, the harvested material swath 17 may be picked up by a loader wagon 24 pulled by a tractor 14. Loader wagons 24 are usually equipped with a collecting device designed as a pick-up and, depending on the equipment, may shred the picked-up harvested material 16 and then transfer it to a certain extent pre-compacted to the actual transport container. Another alternative may be to pick up the harvested material swath 17 by a baler 25 pulled by a tractor 14, such as designed as a so-called square baler 25, wherein the harvested material 16 may then be deposited as a harvested material bale 26 on the field soil 19. This process step 2 is generally followed by process step 2 of collection and removal of the harvested material bales 8, wherein flatbed trailers 27 and forklifts 28 such as tractors 14 with front loaders or so-called telescopic loaders, may be generally used to pick up and transfer the harvested material bales 26.

Process step 2 of storage 10 of the harvested material may, on the one hand, include the storage of the harvested material bales 26. On the other hand, the harvested material 16 picked up by a transport vehicle 23 or a loader wagon 24, for example, may be stored in a silo 29, wherein a flat silo is illustrated in FIG. 1. The harvested material 16 may generally be stored in a flat silo in such a way that the transport vehicle 23 or loader wagon 24 pulled by the tractor 14 delivers the harvested material 16 into the silo 29, where a compaction vehicle 30 compacts the harvested material 16 in a manner known per se by rolling it over and pushing it together several times.

In one or some embodiments, the respective tractor 14, the mower 15, the haymaking machine 20, the windrower 21 (interchangeably termed swather), the forage harvester 22, the transport vehicle 23, the loader wagon 24, the baler 25, the flatbed trailer 27, the forklift 28 and the compaction vehicle 30 may form the agricultural work machines 31 of the forage harvesting process 1 to be controlled and/or optimized and the forage harvesting process chain 13 describing it. It is contemplated that each of the agricultural work machines 31 may be designed to be self-propelled, wherein it is also within the scope of the invention that the agricultural work machines 31 may realize the respective process step 2 autonomously (e.g., without a driver). In this regard, one, some or each of the disclosed agricultural work machines 31 may be automatically operated to perform any of the operations described herein regarding any agricultural job disclosed herein or any forage harvesting process 1 disclosed herein. This is illustrated in the figures in that one, some, or each of the agricultural work machines 31, such as any one, any combination, or all of the following may include computing device 39: the respective tractor 14, the mower 15, the haymaking machine 20, the windrower 21, the forage harvester 22, the transport vehicle 23, the loader wagon 24, the baler 25, the flatbed trailer 27, the forklift 28 and the compaction vehicle 30. In this manner, one, some or each of the agricultural work machines 31 may receive one or both of the optimized values for the work parameters 35 and optimized process steps 2, and using the computing device 39, automatically perform one or more operations of the respective agricultural work machines 31, as discussed herein. Examples of optimized work parameters are disclosed in U.S. application Ser. No. 18/592,668, incorporated by reference herein in its entirety.

The forage harvesting process 1 may therefore be composed of the interaction of the harvested material 16 to be harvested with the process steps 2 forming the forage harvesting process chain 13 and the necessary agricultural work machines 31 assigned to each of them. The agricultural work machines 31 may comprise work units not described in detail here. The mode of operation of the agricultural work machines 31 and the work units assigned to them in each case may be controlled (such as automatically controlled) by changing the work parameters 35 assigned to them in each case.

In one or some embodiments, the forage harvesting process 1 may be controlled (such as optimized) in accordance with one embodiment using an assistance system 32 to be described, wherein the assistance system 32 is configured to support a user 33 in controlling (e.g., optimizing) the agricultural job 11 describing the forage harvesting process 1. An example of an assistance system is disclosed in U.S. application Ser. No. 18/592,668, incorporated by reference herein in its entirety. In one or some embodiments, the control or optimization of the forage harvesting process 1 may comprise at least the planning and/or execution of the forage harvesting process chain 13 effecting the implementation of the agricultural job 11, wherein the forage harvesting process chain 13 comprises, as described, a plurality of process steps 2 (selected in a specified sequence from the plurality of available process steps) and a plurality of agricultural work machines 31 which process (such as automatically process) the agricultural job 11 in the specified sequence.

In one or some embodiments, the assistance system 32 is further configured to optimize the execution of the agricultural job 11 according to predetermined strategies 34a . . . n, wherein the predetermined strategies 34a . . . n are saved in the assistance system 32 and/or are transferred thereto, and wherein the assistance system 32 generates optimized values for the work parameters 35 and optimized sequence of process steps 2 for the forage harvesting process chain 13 and the agricultural work machines 31 forming it using the predetermined strategies 34a . . . n. The predetermined strategies 34a . . . n may be structured in such a way that they determine the optimized values for work parameters 35 and the optimized sequence process steps 2 depending on the quality parameters 36 describing the forage harvesting process 1, and the quality parameters 36 are predetermined or may be predetermined depending on the strategy. The quality parameters 36 may be specified in that each strategy 34a . . . n may be assigned very specific quality parameters 36. The quality parameters 36 may also be specified in that, for example, a user 33 may establish very specific quality parameters 36 for a specific strategy 34a . . . n.

As illustrated in FIG. 1, the assistance system 32 may include a computing device 39. Computing device 39 may include at least one processor 66 and at least one memory 67 in communication with the at least one processor 66. Similarly, the route planning system 50 may include at least one processor 66 and at least one memory 67 in communication with the at least one processor 66. In one or some embodiments, the processor 66 may comprise a microprocessor, controller, PLA, or the like. Similarly, the memory 67 may comprise any type of storage device (e.g., any type of memory). Though the processor 66 and the memory 67 are depicted as separate elements, they may be part of a single machine, which includes a microprocessor (or other type of controller) and a memory. Alternatively, the processor 66 may rely on the memory 67 for all of its memory needs. The memory 67 may comprise a tangible computer-readable medium that include software that, when executed by the at least one processor 66 is configured to perform any one, any combination, or all of the functionality described herein regarding any computing device.

The processor 66 and the memory 67 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. As discussed herein, the assistance system 32 may be configured, using computing device 39, to automatically receive and/or access one or more inputs (e.g., specifiable strategy 34a . . . n and/or quality parameter(s) 36), and automatically generate one or more outputs (e.g., process step(s) and/or work parameter(s) 35). Further, FIG. 1 illustrates a communication interface 68, which may comprise a wired and/or a wireless communication interface that is configured to communicate wired and/or wirelessly (illustrated as wireless communication 69) with one or more external devices. In either instance, the communication interface 68 may be configured to transmit and/or receive data (such as the route plan(s)) via a network, such as via a wireless network and/or via an Ethernet network, and/or via the Internet, as know by one of skill in the art. An example of the communication interface 68 is a network interface controller (alternatively termed a network interface card), which comprises a computer hardware component that is configured to connect the computing device 39 to a network (such as a computer network).

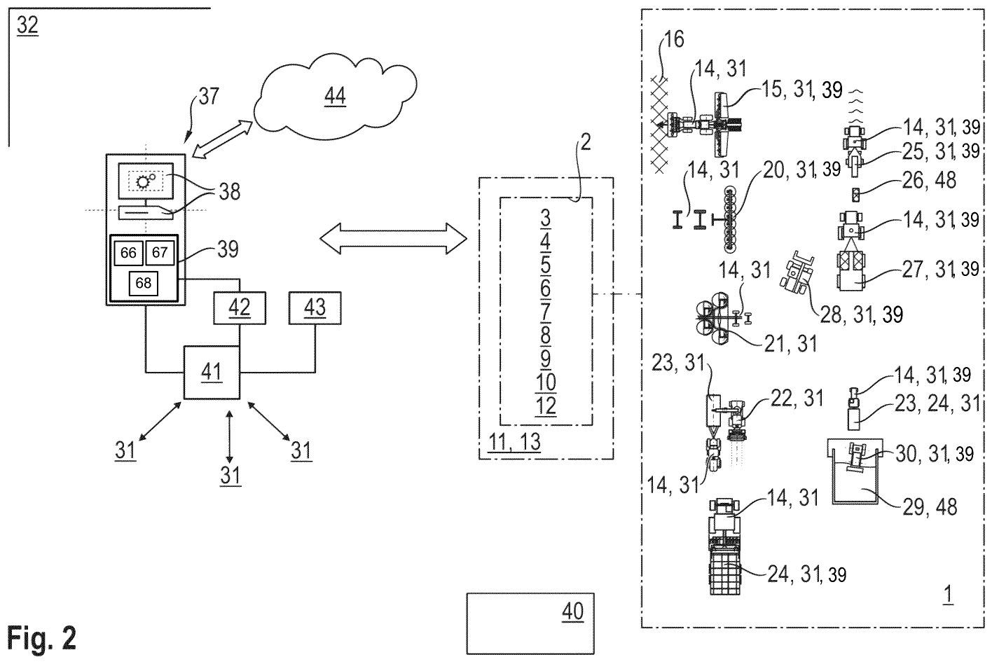

FIG. 2 describes additional details of the assistance system 32. The assistance system 32 may comprise at least one operating device 37, wherein the operating device 37 may be formed by at least one input and display unit 38 (e.g., a touchscreen) and computing device 39, which may comprise at least one processor 66 and at least one memory 67, as discussed above. In one or some embodiments, the operating device 37 may be assigned to one or more of the agricultural work machines 31 (interchangeably termed agricultural production machine) describing the forage harvesting process 1 and/or a stationary unit 40, wherein one or more of the operating devices 37 may be configured to exchange data 41 with one another (e.g., wired and/or wirelessly). The respective operating device 37 may also be configured such that it obtains data 41 from an internal data source 42 associated with the computing device 39 and/or one or more external data sources 43. In one or some embodiments, the computing device 39 assigned to the respective operating device 37 may be partially or completely assigned to a data cloud 44. As previously described, the forage harvesting process 1 comprises one or more process steps 2. Specifically, the process steps 2 may comprise one or more of the process steps 2, including any one, any combination, or all of: decision to start harvesting 12; mowing 3 the harvested material 16; Tedding 4 the harvested material 16; swathing 5 the harvested material 16; swath harvesting using a forage harvester 6; swath harvesting using a baler 7; swath harvesting using a loader wagon 9; collection and removal of harvested material bales 8; and storage 10 of harvested material 16.

Finally, the forage harvesting process 1 to be controlled or optimized is described as an agricultural job 11 (which may comprise one or more operations, such as mechanical operations and/or electrical operations), as previously explained, wherein the description of the agricultural job 11 may include the required process steps 2 and the sequence in which they are performed. The sequence of the performance of the process steps 2 to be performed may also form the respective forage harvesting process chain 13. Depending on the type of forage harvesting process 1 to be controlled or optimized, the forage harvesting process chain 13 defining the respective agricultural job 11 may comprise a plurality of agricultural work machines 31 such as any one, any combination, or all of: mowers 15; haymaking machines 20 (e.g., hay tedders); windrowers 21; harvesting machines (e.g., forage harvesters 22); balers 25 and/or loader wagons 24; transport vehicles (e.g., tractors 14, transport vehicles 23, and/or flatbed trailers 27); forklifts 28; and compaction vehicles 30. In addition, the forage harvesting process chain 13 may comprise the storage 10 of the harvested material 16, wherein the storage 10 may be in the form of harvested material bales 26, or the storage 10 may be in silos 29.

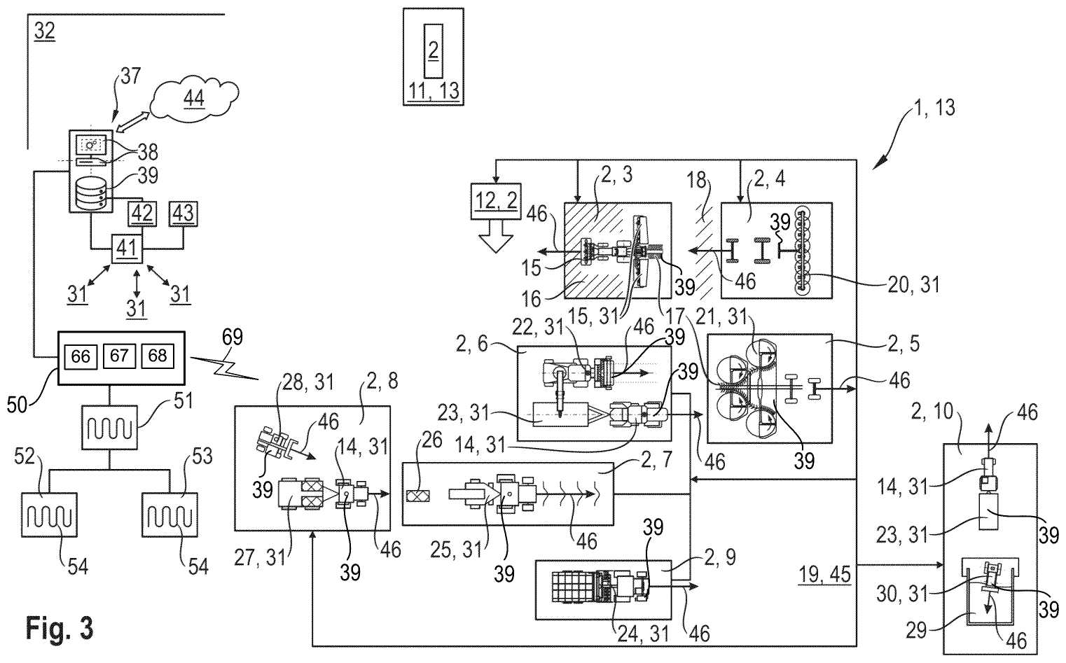

According to FIG. 3, a typical forage harvesting process 1 may be structured such that the assistance system 32 first is configured to automatically determine an optimum time for the start of harvesting 12, wherein the start of harvesting 12 may form the first process step 2 defining the respective forage harvesting process chain 13. The actual process of harvesting may begin with the process step 2 of Mowing 3 (an example of a mechanical operation). As previously described, the mowers 15 may deposit the harvested material 16 in one or more harvested material swaths 17 or in a wide deposit 18 on the field soil 19. In the case of a wide deposit 18, the next process step 2 may be Tedding 4. In so doing, the harvested material 16 may be whirled up and redeposited in a wide deposit 18 so that the harvested material 16 is more or less evenly exposed to wind and sun in order to accelerate the drying of the harvested material 16. If the harvested material 16 is to be placed in a wide deposit 18 on the field soil 19, Swathing 5 follows as another process step 2. As previously described, it may depend on the type of windrower 21 whether one or more crop swaths 17 are deposited on the field soil 19. Regardless of how the harvested material 16 was formed into a harvested material swath 17, it may be finally harvested, wherein a distinction is made here between the process steps 2 of Swath harvesting 6 using a forage harvester 22, Swath harvesting 6 using a baler 25, and Swath harvesting 6 using a loader wagon 24. Process step 2 Swath harvesting 6 using a baler 25 may be followed by process step 2 Collecting and transporting the harvested material bales 8, wherein forklifts 28 and the associated tractor-flatbed trailer combination 14, 27 may be generally used to collect and remove the harvested material bales 26. Another process step 2 of the forage harvesting process chain 13 may be the storage 10 of the harvested material 16 in a silo 29, wherein one or more compacting vehicles 30 and associated tractor-transport vehicle combinations 14, 23 may typically be used here.

One, some or each agricultural work machine 31 integrated into the forage harvesting process chain 13 defined by the agricultural job 11 may cover a travel route 46, to be explained in more detail, on the territory 45 to be worked. Depending on the structure of the forage harvesting process chain 13, the integrated agricultural work machines 31 may be used simultaneously or staggered in time on the territory 45 to be worked. In addition, the agricultural work machines 31 may be used in a specific sequence depending on the respective process step 2 and also may not interfere with or even collide with each other. In order to fulfill all these boundary conditions, the route planning system 50, which is described in detail below, may be used. The route planning system 50 may be configured to automatically create the route plan 51 for a plurality of agricultural work machines 31 of the forage harvesting process chain 13, which may at least partly automatically perform a forage harvesting process 1 in a predetermined sequence (e.g., automatically moving along a predetermined route (as part of a mechanical operation) and/or automatically performing one or more operations along the predetermined route (such as one or both of electrical or mechanical operations along the route)), wherein the forage harvesting process 1 may comprise successive process steps 2, and one, some or each process step 2 may be at least partly automatically performed by a number of the plurality of agricultural work machines 31. The route planning system 50 may also be configured to automatically generate a common route plan 52 for the agricultural work machines 31 of the forage harvesting process chain 13 and/or an individualized route plan 53 for one, some or each agricultural work machine 31. In one or some embodiments, the common route plans 52, 53 may be common to or the same for all of agricultural work machines 31. Each of the individualized or common route plans 52, 53 may comprise a travel route 54 or a plurality of travel routes 54.

In one or some embodiments, the route planning system 50 is assigned to the assistance system 32; in the simplest case, the route planning system 50 is assigned to the memory and computing device 39 of the operating device 37, wherein an operating device 37 is assigned to each agricultural work machine 31. It is also contemplated for the route planning system 50 to be assigned to a central storage and data processing unit 39, and for the common route plan 52 and/or the individualized route plans 53 to be transmitted (e.g., wired and/or wirelessly via the communication interface 68) to the agricultural work machines 31 integrated in the respective forage harvesting process chain 13. It is within the scope of the invention that the storage and computing device 39 may also be assigned to a data cloud 44.

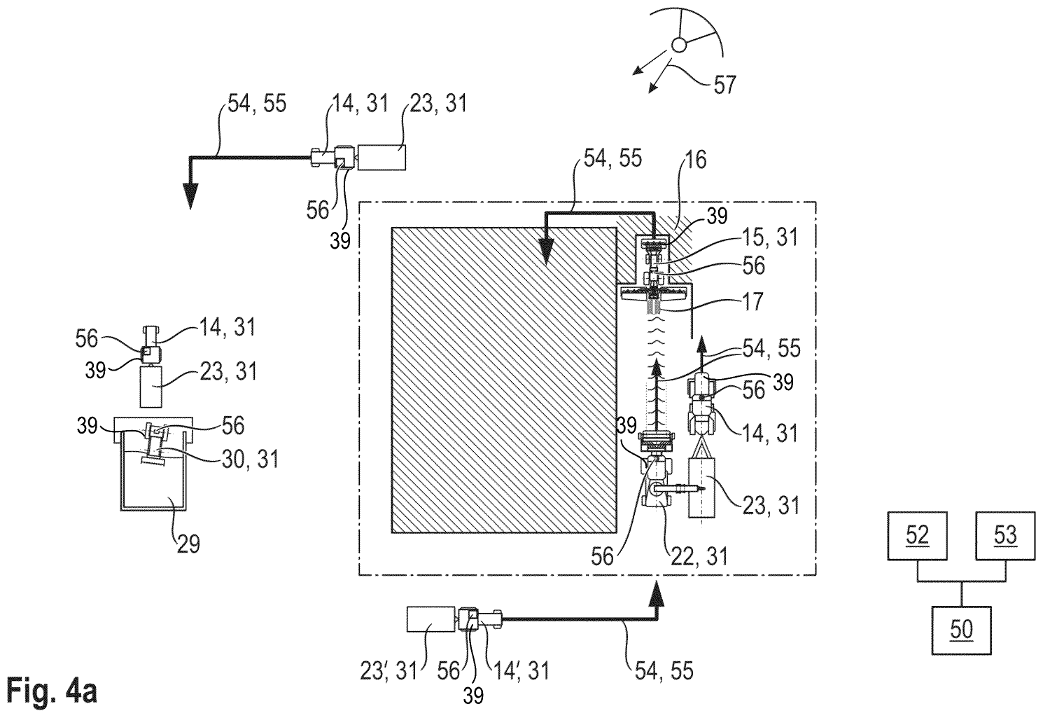

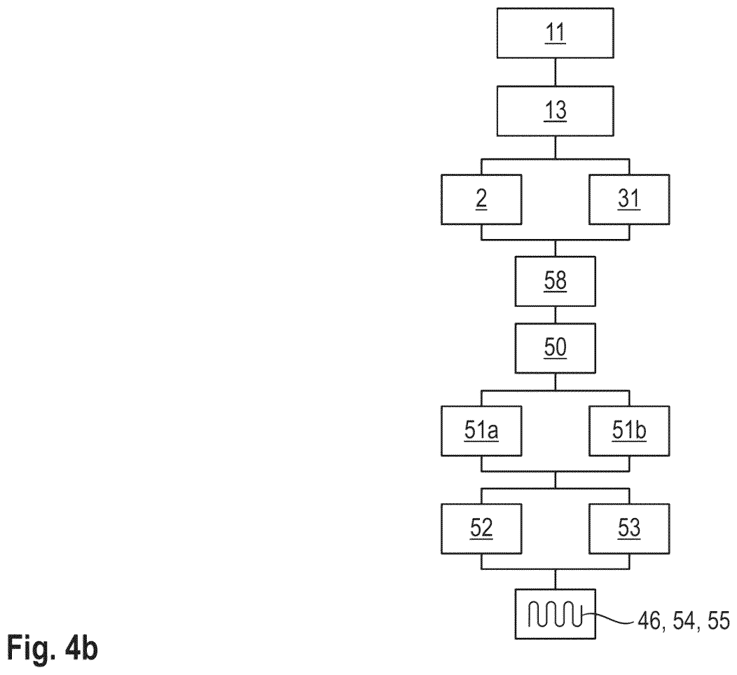

To explain the general functional principle of the route planning system 50 according to one aspect of the invention, FIG. 4a illustrates an example of the cooperation of a selection of agricultural work machines 31 on a territory 45 to be worked. In the depicted example, the harvested material 16 is harvested by a mower 15 and deposited in a harvested material swath 17. The single or multi-part mower 15 moves autonomously or is at least partly automatically carried by a tractor along a travel route 54 (e.g., a mechanical operation). The deposited harvested material swath 17 may then be automatically collected by a forage harvester 22, automatically shredded, and finally automatically transferred to the transport vehicle 23 (which may comprise a transport wagon) pulled by a tractor 14. Both the forage harvester 22 and the tractor-transport vehicle combination 14, 23 may move automatically along travel routes 54. After the transport vehicle 23 is completely filled, it may move along another travel route 54, for example to a silo 29. At the same time, another transport vehicle combination 14′, 23′ may automatically move along a travel route 54 to the forage harvester 22. Ideally, due to at least partly automatic control, the exchange of the transport vehicle combination 14′, 23′ is such that the harvesting process does not have to be interrupted. Each of the depicted examples of travel routes 54 may form an individualized travel route 55 for the respective agricultural work machine 31 with properties individually tailored to the respective agricultural work machine 31. Each of these individualized travel routes 55 may be automatically generated and automatically saved by the route planning system 50 in the individualized route plan 53 and/or the common route plan 52. In the simplest case, all agricultural work machines 31 have data transmission devices 56 (e.g., wireless transmission devices and/or wired transmission devices) through which data may be automatically received and automatically transmitted so that data may be exchanged between the described operating devices 37 (see FIG. 3). The data transmission devices 56 may automatically receive position data, such as GPS data 57, in a manner known per se, so that the exact position of an agricultural work machine 31 integrated in the respective forage harvesting process 1 is known and may be automatically controlled.

FIG. 4b describes details of the route planning system 50 according to one aspect of the invention. As already described, an assistance system 32 is configured to automatically derive a forage harvesting process chain 13 from a defined agricultural job 11. The forage harvesting process chain 13 may comprise, as also already described, a plurality of process steps 2 and a plurality of agricultural work machines 31, which may at least partly automatically process the agricultural job 11 in a predetermined sequence. The information 58 generated by the assistance system 32 and describing the forage harvesting process chain 13 may then be automatically transferred to the route planning system 50. The route planning system 50 may initially be configured to automatically generate a route plan 51a for one process step 2 and/or a route plan 51b for several or all process steps 2. For each agricultural work machine 31 performing (such as at least partly automatically performing) the respective process step 2 or the respective process steps 2, each of the route plans 51a, 51b may comprise, as described, either an individualized route plan 53 for each agricultural work machine 31 or a common route plan 52 that comprises a common route plan for a plurality of agricultural work machines 31. Each route plan 51a, 51b and 52, 53 may comprise one or more travel routes 46, 54 for the respective agricultural work machine 31.

The route planning system 50 is further configured to generate route plans 51a, 51b, 52, 53 such that the route plans 51a, 51b relating to a process step 2 and the route plans 52, 53 relating to the entire forage harvesting process chain 13 comprise travel routes 46, 54, wherein an individualized travel route 55 is assigned to each agricultural work machine 31 of a process step 2 or the entire harvesting process chain 13.

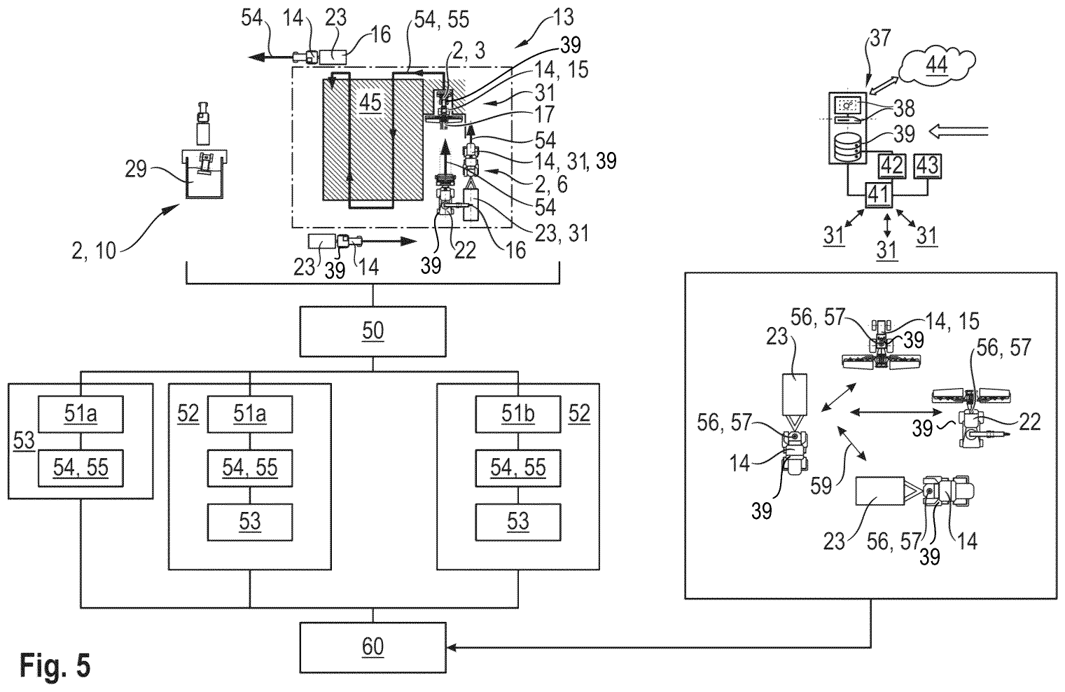

FIG. 5 illustrates the creation of the various route plans 51a, 51b, 52, 53 in detail based on the example according to FIG. 4a. The depicted example of the forage harvesting process chain 13 comprises three process steps 2, namely: Mowing 3; Swath harvesting 6 using a forage harvester 22; and Storage 10 of the harvested material 16.

In one embodiment, the depicted process steps 2 of Mowing 3 and Swath harvesting 6 and storage 10 are processed one after the other, and each process step 2 is processed separately within the forage harvesting process chain 13. For the process step 2 of Mowing 3, the route planning system 50 automatically generates a route plan 51a exclusively for the tractor-mower combination 14, 15 (which, the tractor-mower combination 14, 15, in turn, may at least partly automatically (or entirely automatically) operate based on the route plan 51a). The route plan 51a may comprise a travel route 54 for the tractor-mower combination 14, 15, which also forms the individualized travel route 55 since the route plan 51a is only generated for process step 2 of Mowing 3. In particular, the travel route 54 of the route plan 51a may be used by the tractor-mower combination 14, 15 in order to at least partly automatically (or entirely automatically) operate in order to automatically follow the travel route 54. Since the route plan 51a in this embodiment variant is created for a single agricultural work machine 31, in this case the tractor-mower combination 14, 15, and refers to a single process step 2, this route plan 51a also forms the individualized route plan 53 for the single agricultural work machine 31.

For the process step 2 of Swath harvesting 6, the route planning system 50 also automatically generates a route plan 51a for a single process step 2, but with the difference that the route plan 51a comprises separate travel routes 54 for the forage harvester 22 and the tractor-transport vehicle combination 14, 23 which, on the one hand, include the operation on the territory 45 to be worked as well as the removal of the harvested material 16 and the addition of an empty transport vehicle 23a to the forage harvesting process chain 13. In this regard, the forage harvester 22 may use the route plan 51a in order to in order to: (i) at least partly automatically (or entirely automatically) operate in order to automatically follow the travel route 54 for the forage harvester 22 and the tractor-transport vehicle combination 14, 23; and/or (ii) at least partly automatically (or entirely automatically) operate in order to automatically remove the harvested material 16. On the one hand, the travel routes 54 of this route plan 51a are to be automatically coordinated with each other in such a way that the forage harvester 22 may automatically collect the harvested material swath 17 and safely automatically transfer the harvested material 16 to the transport vehicle 23. On the other hand, the travel routes 54 must also be automatically coordinated with each other in such a way that the agricultural work machines 31 operating together on the territory 45 to be automatically worked work jointly in an automatically coordinated manner during the overloading of the harvested material 16 and do not hinder or collide with each other. Even when a plurality of agricultural work machines 31 are used in a single process step 2, the route planning system 50 automatically generates an individualized travel route 55 for each agricultural work machine (with each respective agricultural work machine automatically following the respective individualized travel route 55). This initially results in an individualized route plan 53 being assigned to each agricultural work machine 31 integrated in the process step 2. However, these individualized route plans 53 may be automatically derived from a common route plan 52, which may fulfill the above-mentioned boundary conditions.

Given the backdrop that the process step 2 of Storage 10 does not generally take place in the area of the territory 45 to be worked, the automatic creation of a route plan 51a for the single process step 2 of Storage 10, which in addition to the storage of the harvested material 16 in a silo 29 may also include the storage of harvested material bales 26, which is not described in more detail, follows the planning of the common and individualized route plans 52, 53 described above with respect to the combination of the forage harvester 22 and tractor-transport vehicle combination 14, 23 due to the plurality of agricultural work machines 31 involved in the process step. As discussed above, storage 10 of the harvested material 16 may include the storage of the harvested material bales 26 and/or the harvested material 16 may be collected by the transport vehicle 23 or the loader wagon 24 for storage in the silo 29. Regardless, the route plan 51a may be used by at least one device (e.g., the transport vehicle 23 or the loader wagon 24) for at least partly automatic (such as entirely automatic) operation of the at least one device for storage of the harvested material bales and/or the harvested material 16.

In an alternative embodiment, the different process steps 2 may be processed simultaneously on a territory 45 to be worked. For the exemplary embodiment described here by way of example, the process steps 2 of Mowing 3, Swath harvesting 6 and Storage 10 may be processed in immediate succession so that the involved agricultural work machines 31 operate at least partly simultaneously on the territory 45 to be worked. In this case, the route planning system 50 may automatically generate a route plan 51b that combines the previously described travel routes 54, 55 in a cross-process-step route plan 51b. The forage harvesting process chain 13 to be described by the cross-process-step route plan 51b starts in the instance described by way of example with the mowing 3 the harvested material 16 and its automatic placement in a harvested material swath 17, which may be at least partly automatically (such as entirely automatically) collected by the forage harvester 22 in the subsequent process step 2, automatically shredded, and at least partly automatically (such as entirely automatically) transferred to the transport vehicle 23 at least partly automatically (such as entirely automatically) pulled by a tractor 14. In the instance described here, a filled transport vehicle 23 may then be at least partly automatically (such as entirely automatically) driven to a silo and at least partly automatically (such as entirely automatically) emptied there. At the same time, a still empty tractor-drawn transport vehicle 23a is driven to the forage harvester 22. Therefore in such an instance, four agricultural work machines 31, the tractor-drawn mower 15, the forage harvester 22, the tractor-drawn transport vehicle 23 and the tractor-drawn empty transport vehicle 23′, operate at least partly automatically (such as entirely automatically) simultaneously on the territory 45 to be worked. As discussed above, the various outputs generated by the route planning system 50, such as the route plans, may be used in order to at least partly automatically (such as entirely automatically) control any one, any combination, or all of: four agricultural work machines 31; the tractor-drawn mower 15; the forage harvester 22; the tractor-drawn transport vehicle 23; or the tractor-drawn empty transport vehicle 23′.

As in the previously described design variant, the travel routes 54 of this route plan 51b may be automatically coordinated with each other in such a way that the forage harvester 22 may automatically collect the harvested material swath 17 and automatically safely transfer the harvested material 16 to the transport vehicle 23. On the other hand, the travel routes 54 may also be coordinated with each other in such a way that the agricultural work machines 31 automatically operating together on the territory 45 to be worked work jointly in an automatically coordinated manner while automatically collecting and automatically overloading the harvested material 16 and do not hinder or collide with each other. The route planning system 50 may also automatically generate an individualized travel route 55 for each agricultural work machine when a plurality of agricultural work machines 31 are used in several automatically simultaneously processed process steps 2. This initially may result in an individualized route plan 53 being automatically assigned to each agricultural work machine 31 integrated in the process step 2. However, these individualized route plans 53 may be derived from a common route plan 52, which fulfills the above-mentioned boundary conditions.

US Patent Application Publication No. 2007/233374 A1, incorporated by reference herein in its entirety, discloses examples of planning travel routes 54, 55. Further, the route plans 51a, 51b automatically generated by the route planning system 50 may be implemented in such a way that the agricultural work machines 31 automatically operating together on the territory 45 to be worked automatically collaborate in a coordinated manner and do not hinder or collide with each other when automatically collecting and automatically overloading the harvested material 16, when automatically generating the harvested material swath, while automatically removing the harvested material 16 and automatically collecting empty transport vehicles 23′ in the forage harvesting process chain 13, it must be ensured that the agricultural work machines 31 automatically operating on the territory 45 to be worked are in a mutual data exchange 59. In the simplest case, the agricultural work machines 31 automatically exchange their GPS data 57 generated by the data transmission device 56 with each other. Based on this data exchange 59, an automatic dynamic adaptation 60 of a wide variety of the various route plans 51a, 51b, 52, 53 is automatically performed so that the agricultural work machines 31 involved in the respective process step and the entire forage harvesting process chain 13 are automatically informed of the occurrence of a situation that makes processing the planned travel route 54, 55 impossible, or collision risks are recognized automatically by the route planning system 50, and the route planning system 50 then automatically dynamically adapts all planned travel routes 54, 55 and the route plans 51a, 51b, 52, 53 comprising these travel routes 54, 55. In this regard, one or more levels of automatic control are disclosed, including any one, any combination, or all of:
(i) at least partly automatic (or entirely automatic) generation of the various plans (e.g., the route planning system 50 automatically generating the various route plans 51a, 51b, 52, 53 (which may include indications of the physical paths or routes of one or more electronic devices and/or indications of operations to be performed (such as to be performed by the electronic devices at various parts of the physical paths or routes of one or more electronic devices));
(ii) at least partly automatic (or entirely automatic) implementation of the various plans (e.g., the agricultural work machines 31; the tractor-drawn mower 15; the forage harvester 22; the tractor-drawn transport vehicle 23; or the tractor-drawn empty transport vehicle 23′ at least partly automatically (or entirely automatically) implementing the various plans in order to automatically control one or both of the route and/or the operations performed by the respective device along the route);
(iii) at least partly automatic (or entirely automatic) dynamic updating of the various plans. For example, the route planning system 50 may perform any one, any combination, or all of: (A) automatically and dynamically monitor one or more types of data, such as one or both of location data (e.g., GPS data) or operation data (e.g., data indicative of the operation) for any one, any combination, or all of the automatically controlled machines (e.g., one or more of the agricultural work machines 31; the tractor-drawn mower 15; the forage harvester 22; the tractor-drawn transport vehicle 23; or the tractor-drawn empty transport vehicle 23′); (B) responsive to the automatic monitoring, the route planning system 50 may automatically and dynamically determine whether there is any conflicts in routes and/or in operations (e.g., any one, any combination, or all of: identification of an obstacle that results in change of the route of a respective vehicle into the potential path of another vehicle resulting in a potential collision; breakdown of a machine resulting in potential collision; or work interruption(s)); (C) responsive to the automatic determining of conflicts, the route planning system 50 may automatically and dynamically update the plans (such as the route plans 51a, 51b, 52, 53) for any one, any combination, or all of the automatically controlled machines; or (D) responsive to the automatic updating of the plans, the route planning system 50 may automatically and dynamically send the updated plans (such as the updated route plans 51a, 51b, 52, 53) to any one, any combination, or all of the automatically controlled machines; and
(iv) at least partly automatic (or entirely automatic) implementation of the updated plans (e.g., the agricultural work machines 31; the tractor-drawn mower 15; the forage harvester 22; the tractor-drawn transport vehicle 23; or the tractor-drawn empty transport vehicle 23′ at least partly automatically (or entirely automatically) implementing the various plans in order to automatically control one or both of the route and/or the operations performed by the respective device along the route).

In this regard, the route planning system 50 is configured to automatically and dynamically adapt the one or both of the common route plan or the individualized route plan based on one or both of: operation of one or more of the plurality of agricultural work machines (e.g., the location and/or the mechanical operation of the agricultural work machines (such as whether a respective agricultural work machine is stopped or broken-down)); or identification of at least one aspect of the territory to be worked (e.g., an obstacle in the territory that may necessitate a change in the previously generated route plan for a respective agricultural work machine). In one or some embodiments, the route planning system is configured to receive location data and/or operation data for the plurality of the agricultural work machines. Further, the route planning system is configured to dynamically adapt the one or both of the common route plan or the individualized route plan by: automatically determining, based on one or both of the location data or the operation data for some or all the plurality of the agricultural work machines, whether there is one or both of a conflict in routes or in operations for the some or all the plurality of the agricultural work machines; responsive to automatically determining that there is the one or both of the conflict in routes or in the operations for the some or all the plurality of the agricultural work machines, automatically generate one or both of an updated common route plan or at least one updated individualized route plan (e.g., in order to avoid the conflict in routes or in operations); and automatically transmit (e.g., transmit in real-time) the one or both of the updated common route plan or the at least one updated individualized route plan to at least one of the plurality of agricultural work machines. In one or some embodiments, any one, any combination, or all of the steps to dynamically adapt the one or both of the common route plan or the individualized route plan may be performed in real-time, such as any one, any combination, or all of: automatically determining whether there is one or both of a conflict in routes or in operations (e.g., whether there is a deviation from the previously generated route(s) that is indicative that the conflict in routes or in operations); automatically generate one or both of the updated common route plan or at least one updated individualized route plan; and automatically transmit the updated common route plan or at least one updated individualized route plan. In one or some embodiments, real-time may comprise performing a respective operation immediately (e.g., within less than 5 minutes, within less than 1 minute, within less than 10 seconds, within less than 1 second). In this regard, in one or some embodiments, the monitoring and/or the updating by the route planning system 50 may be performed in real-time.

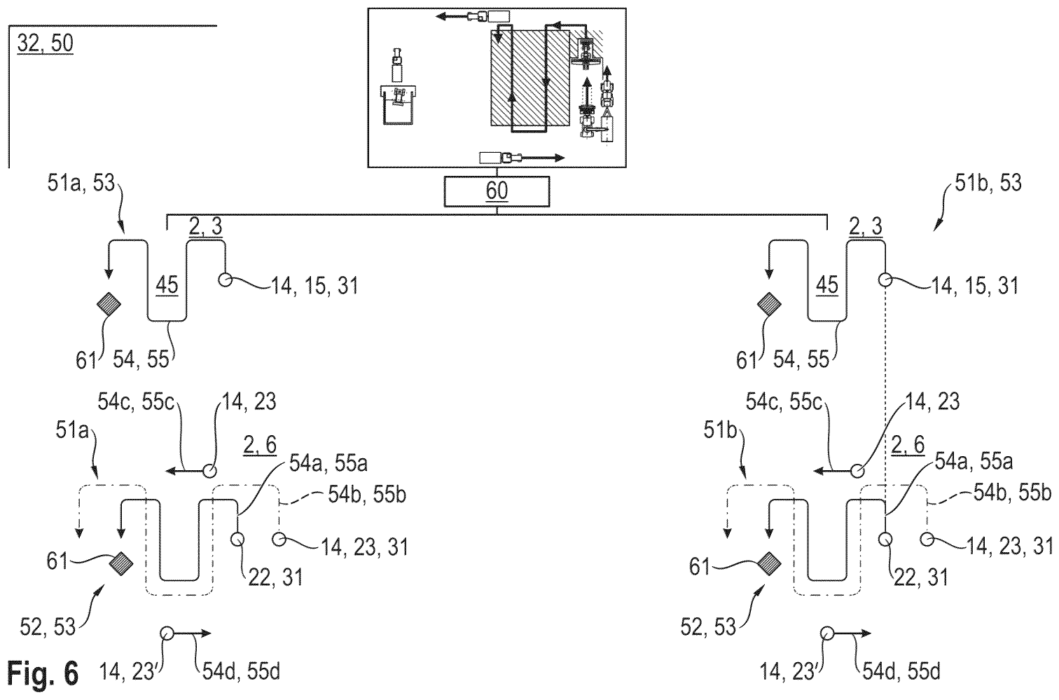

FIG. 6 describes the structure of the dynamic adaptation 60 of the various route plans 51a, 51b, 52, 53 in more detail. In the embodiment in which only the tractor-mower combination 14, 15 as the only agricultural work machine 31 on the territory 45 to be worked processes a single process step 2, in this case Mowing 3 (upper left representation in FIG. 6), the route plan 51a comprises only a single travel route 54 which at the same time forms the individualized travel route 55. In this case, the dynamic adaptation 60 of the route plan 51a which is also the individualized route plan 53, and the associated travel route 54, 55 is limited to the fact that dynamic adaptation 60 may (or must) be made due to obstacles 61 (e.g., a tree stump along the route), or due to the fact that the agricultural work machine 31 itself may be stopped (e.g., suffering from a break down) or may interrupt the processing of the route plan 51a.

In the embodiment in which the forage harvester 22 and the tractor-transport vehicle combination 14, 23 assigned thereto work as agricultural work machines 31 on the territory 45 to be worked in a single process step 2, in this case Swath harvesting 6 using the forage harvester 22 (bottom left-hand illustration in FIG. 6), the route plan 51a comprises a travel route 54a for the forage harvester 22 to automatically follow and a travel route 54b for the tractor-transporter combination 14, 23 to automatically follow, which may also form the individualized routes 55a, b. In addition, the route plan for the tractor-transport vehicle combination comprises further travel routes 54c and 54d, which depict the automatic removal of the filled transport vehicle 23 and the addition of an empty transport vehicle 23′ in the single process step 2, wherein the additional travel routes 54c, 54d also form the respective individualized automatic travel routes 55c and 55d. In this embodiment, on the one hand, an individualized route plan 53 may be assigned to each agricultural work machine 31 integrated into the process step 2 of Swath harvesting 6 using the forage harvester 22. At the same time, the individual route plans 53 are combined in a common route plan 52 in the route planning system 50. As previously described, the travel routes 54a-d of this route plan 51a may be coordinated in such a way that the forage harvester 22 may automatically collect the harvested material swath 17 and safely automatically transfer the harvested material 16 to the transport vehicle 23. On the other hand, the travel routes 54a-d may also be coordinated with each other in such a way that the agricultural work machines 31 automatically operate together (e.g., automatically following the travel routes 54a-d) on the territory 45 to be automatically worked automatically collaborate in a coordinated manner during the automatically transfer of the harvested material 16 and do not hinder or collide with each other. Obstacles 61 and the failure of agricultural work machines 31 or work interruptions may also be taken into account in this instance. Therefore, the automatic dynamic adaptation 60 of the route plans 51a, 52, 53 and the routes 54a-d, 55a-d assigned to them may be subject to significantly more complex relationships. However, since the route planning system 50 is such that it automatically receives, via data exchange 59, the GPS data describing the positions of the involved agricultural work machines and additionally the described information 58, the route planning system may automatically, dynamically and highly flexibly adapt the route plans 51a, 52, 53 and the routes 54a-d, 55a-d assigned to them.

In another embodiment, as described, it is provided that different process steps 2 are processed simultaneously (such as at least partly simultaneously) on a territory 45 to be worked. For the embodiment described here by way of example, the process steps 2 of Mowing 3 and swath harvesting 6 described in the left-hand representation in FIG. 6 may be processed in immediate succession so that the involved agricultural work machines 31 operate at least partly simultaneously on the territory 45 to be worked. In this case, a route plan 51b is generated by the route planning system 50 and combines the previously described travel routes 54, 54a-d and 55, 55a-d in a cross-process-step route plan 51b.

The forage harvesting process chain 13 to be described by the cross-process-step route plan 51b starts in the instance described by way of example with the mowing 3 the harvested material 16 and its placement in a harvested material swath 17, which is automatically collected by the forage harvester 22 in the subsequent process step 2, automatically shredded, and automatically transferred to the transport vehicle 23 pulled by a tractor 14. In the instance described here, a filled transport vehicle 23 is then automatically driven to a silo and emptied there. At the same time, a still empty tractor-drawn transport vehicle 23′ is automatically driven to the forage harvester 22. In this regard, filled transport vehicle 23 and the empty tractor-drawn transport vehicle 23′ may automatically and simultaneously perform different parts of the same task (and may also automatically perform at least a part of the same task of the respective process step but at different times). Therefore in such an instance, four agricultural work machines 31, the tractor-drawn mower 15, the forage harvester 22, the tractor-drawn transport vehicle 23 and the tractor-drawn empty transport vehicle 23′, operate automatically at least partly (or entirely) simultaneously on the territory 45 to be worked.

In this instance as well, the travel routes 54, 54a-d may be coordinated with each other in such a way that the agricultural work machines 31 automatically operating together on the territory 45 to be worked automatically collaborate in a coordinated manner and do not hinder or collide with each other. In addition, obstacles 61 and the breakdown of agricultural work machines 31 or work interruptions may be taken into account. Therefore, the automatic dynamic adaptation 60 of the route plans 51b, 52, 53 and the travel routes 54, 54a-d, 55, 55a-d assigned to them may be subject to even more complex relationships. However, since the route planning system 50 is such that it automatically receives via data exchange 59 the GPS data 57 describing the positions of the involved agricultural work machines 31 and additionally the described information 58, the route planning system may automatically, dynamically and highly flexibly adapt the route plans 51b, 52, 53 and the travel routes 54, 54a-d, 55, 55a-d assigned to them (and in turn send the adapted route plans 51b, 52, 53 and/or the adapted travel routes 54, 54a-d, 55, 55a-d to the various machines in order for the various machines to automatically modify their respective operations in order to avoid collisions or the like).

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Forage harvesting process |
| 2 | Process step |
| 3 | Mowing |
| 4 | Turning/tedding |
| 5 | Swathing |
| 6 | Swath harvesting using a forage harvester |
| 7 | Swath harvesting using a baler |
| 8 | Collection and removal of the bales |
| 9 | Swath harvesting using a loader wagon |
| 10 | Storage of harvested material |
| 11 | Agricultural job |
| 12 | Start of harvesting |
| 13 | Forage harvesting process chain |
| 14 | Tractor |
| 15 | Mower |
| 16 | Harvested material |
| 17 | Harvested material swath |
| 18 | Wide deposit |
| 19 | Field soil |
| 20 | Haymaking machine |
| 21 | Windrower |
| 22 | Forage harvester |
| 23 | Transport vehicles |
| 24 | Loader wagon |
| 25 | Baler |
| 26 | Harvested material bales |
| 27 | Flatbed trailer |
| 28 | Forklift |
| 29 | Silo |
| 30 | Compaction vehicle |
| 31 | Agricultural production machine |
| 32 | Assistance system |
| 33 | User |
| 34a . . . n | Specifiable strategy |
| 35 | Operating parameter |
| 36 | Quality parameter |
| 37 | Operating device |
| 38 | Input and display unit |
| 39 | Memory and data processing unit |
| 40 | Stationary unit |
| 41 | Data |
| 42 | Internal data source |
| 43 | External data source |
| 44 | Data cloud |
| 45 | Territory to be worked |
| 46 | Travel route |
| 47 | |
| 48 | |
| 49 | |
| 50 | Route planning system |
| 51a, b | Route plan |
| 52 | Common route plan |
| 53 | Individualized route plan |
| 54 | Travel route |
| 55 | Individualized travel route |
| 56 | Data transmission device |
| 57 | GPS data |
| 58 | Information |
| 59 | Data exchange |
| 60 | Dynamic adaptation |
| 61 | Obstacle |
| 62 | |
| 63 | |
| 64 | |
| 65 | |
| 66 | Processor |
| 67 | Memory |
| 68 | Communication interface |
| 69 | Wireless communication |

1. A route planning system comprising:
at least one communication interface configured to communicate with a plurality of agricultural work machines; and
at least one computing device configured to:
automatically generate one or both of a common route plan that is common for the plurality of the agricultural work machines of a forage harvesting process chain or an individualized route plan for each of the plurality of agricultural work machines, wherein the forage harvesting process chain comprises the plurality of agricultural work machines configured to perform a forage harvesting process in a predetermined order, wherein the forage harvesting process comprises successive process steps and each process step being performed by a number of the plurality of agricultural work machines; and
at least partly automatically transmit, via the at least one communication interface, the one or both of common route plan that is common for the plurality of the agricultural work machines of a forage harvesting process chain or the individualized route plan for each of the plurality of agricultural work machines; and
wherein the one or both of common route plan the individualized route plan are indicative to the plurality of agricultural work machines to at least partly automatically perform one or more operations in performing the forage harvesting process.

2. The route planning system of claim 1, wherein the one or both of common route plan the individualized route plan are indicative of coordinated operation of agricultural work machines with each other in such a way that the plurality of agricultural work machines automatically operating together on territory to be worked for performing the forage harvesting process automatically collaborate in a coordinated manner and do not hinder or collide with each other.

3. The route planning system of claim 2, wherein the route planning system is further configured to automatically and dynamically adapt the one or both of the common route plan or the individualized route plan based on one or both of: operation of one or more of the plurality of agricultural work machines; or identification of at least one aspect of the territory to be worked.

4. The route planning system of claim 3, wherein the route planning system is further configured to receive location data for the plurality of the agricultural work machines; and
wherein the route planning system is configured to dynamically adapt the one or both of the common route plan or the individualized route plan by:
automatically determining, based on the location data for some or all the plurality of the agricultural work machines, whether there is one or both of a conflict in routes or in operations for the some or all the plurality of the agricultural work machines;
responsive to automatically determining that there is the one or both of the conflict in routes or in the operations for the some or all the plurality of the agricultural work machines, automatically generate one or both of an updated common route plan or at least one updated individualized route plan; and
automatically transmit the one or both of the updated common route plan or the at least one updated individualized route plan to at least one of the plurality of agricultural work machines.

5. The route planning system of claim 4, wherein the route planning system is configured to:
determine, based on GPS data for the some or all the plurality of the agricultural work machines, whether at least one of the plurality of agricultural work machines is stopped or interrupted in its processing along its respective route;
determine, based on the at least one of the plurality of agricultural work machines being stopped or interrupted in its processing along its respective route, whether this is a potential collision with another of the plurality of agricultural work machines;
responsive to determining the potential collision, updating the respective route of the another of the plurality of agricultural work machines; and
transmitting, to the another of the plurality of agricultural work machines, the updated respective route of the another of the plurality of agricultural work machines.

6. The route planning system of claim 4, wherein the route planning system is configured to:
determine whether there is an obstacle along a respective route of at least one of the plurality of agricultural work machines;
determine, based on the obstacle along the respective route, whether this is a potential collision with another of the plurality of agricultural work machines;
responsive to determining the potential collision, updating the respective route of the another of the plurality of agricultural work machines; and
transmitting, to the another of the plurality of agricultural work machines, the updated respective route of the another of the plurality of agricultural work machines.

7. The route planning system of claim 2, wherein one of the plurality of the agricultural work machines are configured to perform one process step and another of the plurality of the agricultural work machines is configured to perform a successive process step; and
wherein the route planning system is configured to generate the one or both of the common route plan or the individualized route plan for the one of the plurality of the agricultural work machines and the another of the plurality of the agricultural work machines in a temporal and geographical sequence so that no collisions occur between the one of the plurality of the agricultural work machines and the another of the plurality of the agricultural work machines.

8. The route planning system of claim 7, wherein at least two of the plurality of agricultural work machines are used in a single process step; and
wherein the route planning system is configured to generate the one or both of the common route plan or the individualized route plan for the at least two of the plurality of agricultural work machines in order for the at least two of the plurality of agricultural work machines to work in a coordinated manner in automatically performing the single process step.

9. The route planning system of claim 1, wherein the route planning system is configured to generate one or both of the common route plan for the agricultural work machines for a respective process step of the forage harvesting process chain or the individualized route plan for each agricultural work machine for the respective process step of the forage harvesting process chain.

10. The route planning system of claim 1, wherein the route planning system is configured to generate one or both of the common route plan for the agricultural work machines for each process step of the forage harvesting process chain or the individualized route plan for each agricultural work machine for each process step of the forage harvesting process chain.

11. The route planning system of claim 1 wherein respective common route plans and respective individualized route plans comprise travel routes; and
wherein each of the plurality of agricultural work machines is assigned an individualized route in at least one of the respective common route plans and the respective individualized route plans.

12. The route planning system of claim 1, wherein the route planning system is further configured to receive the forage harvesting process chain that is generated by an assistance system; and
wherein the assistance system is configured to create the forage harvesting process chain from a description of an agricultural job transferred to the assistance system.

13. The route planning system of claim 1, wherein the forage harvesting process to be optimized is described as an agricultural job;
wherein the agricultural job comprises the process steps and a sequence of execution of the process steps;
wherein the sequence of execution of the process steps forms a respective forage harvesting process chain; and
wherein the route planning system is configured to create one or both of the route plan for a respective process step or the route plan for all of the process steps.

14. The route planning system of claim 13, wherein the route planning system is configured to create both the route plan for the respective process step and the route plan for all of the process steps.

15. The route planning system of claim 1, wherein the plurality of agricultural work machines active on a territory to be worked each have a data transmission device;
wherein the data transmission devices are configured to enable a data exchange between the plurality of agricultural work machines and the route planning system; and
wherein the route planning system is configured to automatically and dynamically adapt the one or both of the common route plan or the individualized route plan based on the data exchange.

16. The route planning system of claim 1, wherein the plurality of agricultural work machines comprise at least two agricultural work machines configured to perform a same task of respective process step; and
wherein the route planning system is configured to generate the common route plan or the individualized route plan for the at least two agricultural work machines in order to automatically perform at least a part of the same task of the respective process step but at different times.

17. The route planning system of claim 16, wherein the route planning system is configured to generate the common route plan or the individualized route plan for the at least two agricultural work machines in order to automatically and simultaneously perform different parts of the same task.

18. The route planning system of claim 17, wherein the at least two agricultural work machines comprise transport vehicles; and
wherein the route planning system is configured to generate the common route plan or the individualized route plan for the transport vehicles so that a filled transport vehicle is automatically driven to a silo at least partly simultaneously while an empty transport vehicle is automatically driven to a forage harvester.
